(19) United States
(12) Patent Application Publication
(10) Pub. No.: US 2014/0304588 A1
(43) Pub. Date: Oct. 9, 2014

(54) CREATING PAGE SNAPSHOTS

(71) Applicant: Alibaba Group Holding Limited, George Town (KY)

(72) Inventors: Ji Li, Beijing (CN); Xiaozhe Wang, Beijing (CN); Jiale Zhi, Beijing (CN); Qiu Li, Beijing (CN); Shengbo Ma, Beijing (CN); Zhu Zhu, Beijing (CN)

(21) Appl. No.: 14/227,568

(22) Filed: Mar. 27, 2014

(30) Foreign Application Priority Data
Apr. 3, 2013 (CN) 201310115882.1

(51) Int. Cl. G06F 17/22

(52) U.S. Cl. CPC G06F 17/2247
USPC 715/234

(57) ABSTRACT

Creating a page snapshot is disclosed, including: receiving data associated with a webpage; determining that a page resource associated with the webpage is associated with delayed loading, wherein during a delayed loading process the page resource is configured to be loaded in response to a trigger event; loading the page resource without the trigger event based at least in part on modifying one or more attributes associated with the page resource in the received data associated with the webpage; rendering the loaded page resource; and creating a page snapshot of the webpage including the rendered page resource.

### CROSS REFERENCE TO OTHER APPLICATIONS

This application claims priority to People's Republic of China Patent Application No. 201310115882.1 entitled A METHOD AND DEVICE FOR TAKING PAGE SNAPSHOTS, filed Apr. 3, 2013 which is incorporated herein by reference for all purposes.

### FIELD OF THE INVENTION

The present application involves the field of webpage technology. In particular, the present application describes taking page snapshots by preventing delayed page loading.

### BACKGROUND OF THE INVENTION

As the Internet develops, users have increasingly high requirements for website appearance. At the same time, there is an increasing number of resources contained in each webpage. When user network conditions are poor, webpage loading speed decreases, which can lead to a poor user experience.

To resolve this problem, developers have employed delayed loading technology for pages that include a large volume of page resources. An example of a page resource is an image.

Delayed loading, also known as lazy loading, was proposed to avoid certain unnecessary performance overhead. Delayed loading is the practice of only actually executing data loading operations on certain data when the data is actually needed to be loaded for a user at the webpage. When a delayed loading technique is invoked to load an object, a proxy object is returned, and the database operating statement is only transmitted when the content of the object is actually to be used. For example, during browsing of a webpage, loading of an image only begins when the user scrolls to a portion of the page that is in the vicinity of the image while blank pages or other elements are substituted for images that are not yet browsed by the user.

However, delayed loading technology may interfere with the creation of page snapshots. A page snapshot comprises a screenshot or screen capture of the contents of a webpage. Because delayed loading technology prevents loading of certain images until a user interaction to view the images is received, the page snapshot created of a webpage at which delayed loading is implemented will likely include blank portions. The blank portions represent the delayed images that had not yet been triggered to be loaded and rendered. As a result, delayed loading technology may result in the inability to capture a page with fully loaded page resources (such as images) when a page snapshot is to be taken of the page. FIG. 1 shows an example of a page snapshot of a webpage. In the example, because delayed loading is implemented at the webpage, page snapshot 100 includes blank region 102 where delayed loading images had not yet been triggered to be loaded and rendered. Due to the presence of blank region 102, page snapshot 100 does not represent a fully loaded version of the webpage.

A page snapshot may be used during the capturing and backing up of a page while a search engine is recording the page and storing it in the server's buffer. However, during the capturing process, because delayed loading technology is employed on a page that includes a large volume of resources, a snapshot of the page can be taken and saved when the page has not yet been fully loaded. The page snapshot may be available to a user when a link to the page has been returned among search results. The user may select the “page snapshot” link and in response, the search engine displays the associated page snapshot. However, if delayed loading was implemented for the page, the displayed page snapshot may include one or more blank regions. As a result, a user is not able to receive an accurate preview of the page via the incomplete/partially blank page snapshot.

### BRIEF DESCRIPTION OF THE DRAWINGS

Various embodiments of the invention are disclosed in the following detailed description and the accompanying drawings.

FIG. 1 shows an example of a page snapshot of a webpage.

FIG. 2 is a diagram showing an embodiment of a system for creating a snapshot of a webpage.

FIG. 3 is a flow diagram showing an embodiment of a process for creating a snapshot of a webpage.

FIG. 4 is a flow diagram showing an embodiment of a process for preventing delayed loading.

FIG. 5 is a flow diagram showing an embodiment of a process for triggering a process of preventing delayed loading.

FIG. 6 is a diagram showing an example of a page snapshot of a webpage for which preventing delayed loading was applied.

FIG. 7 is a diagram showing an embodiment of a system for preventing delayed loading.

FIG. 8 is a diagram showing an example of a preventing module.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of creating page snapshots are described herein. Data associated with a webpage is received. A page resource associated with the webpage that is associated with delayed loading is determined. The page resource associated with delayed loading is configured to be loaded in response to a trigger event. The page resource is loaded without the trigger event based at least in part on modifying one or more attributes associated with the page resource in the received data associated with the webpage. The loaded page resource is rendered. A page snapshot including the rendered page resource is created.

Snapshots of webpages may be desired in various applications. As a first example, a web server may be configured to periodically initiate the creation of a page snapshot of each webpage associated with each of one or more websites. As a second example, a search engine may be configured to initiate the creation of a page snapshot of each webpage that it has indexed so that the page snapshot can be accessed by a user when the associated webpage is presented within search results.

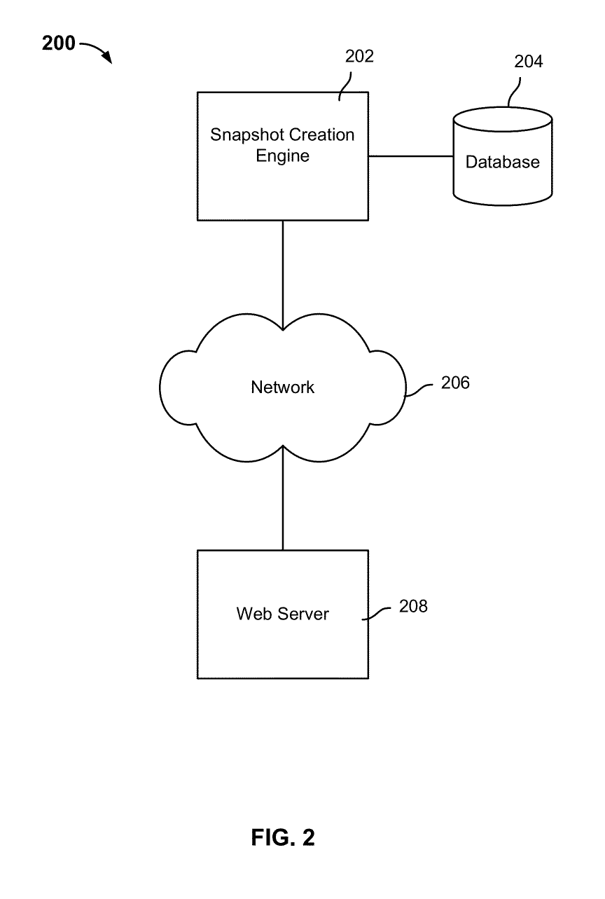

FIG. 2 is a diagram showing an embodiment of a system for creating a snapshot of a webpage. In the example, system 200 includes snapshot creation engine 202, database 204, network 206, and web server 208. Network 206 includes high-speed networks and/or telecommunications networks. Snapshot creation engine 202 is configured to communicate to web server 208 over network 206.

Web server 208 may host on one or more websites. Each website may include one or more webpages. Snapshot creation engine 202 is configured to create page snapshots of each of various webpages. For example, snapshot creation engine 202 is configured to periodically create a page snapshot of each webpage included in a website hosted by web server 208. Page snapshots (e.g., with associated timestamps and/or version numbers) can be stored by snapshot creation engine 202 at database 204. For example, for an entity (e.g., a search engine) that needs to access a page snapshot associated with a webpage, snapshot creation engine 202 can provide the entity a link to the page snapshot stored at database 204.

For example, to create a snapshot of a webpage, first snapshot creation engine 202 retrieves data (e.g., an HTML webpage file) associated with that webpage from web server 208. Snapshot creation engine 202 stores a local copy of the data associated with the webpage. Snapshot creation engine 202 begins to load and/or render the page resources contained in the data associated with the webpage. Certain page resources of the webpage may be associated with delayed loading. In some embodiments, a page resource associated with delayed loading is associated with two pieces of content: a substitute content and an original content. For example, if the page resource were an image, then the substitute content can comprise a blank image (or any image of a smaller size) while the original content comprises the image that is to be presented in the fully rendered webpage. Loading of a page resource associated with delayed loading will first load the substitute content corresponding to the page resource and then load the original content when a trigger event (e.g., a certain user interaction with the webpage that causes the page resource to be within a display area) is detected. However, during a page snapshot creation process, trigger events do not occur. As such, to prevent page resources associated with delayed loading from not loading properly or put another way, to prevent creating a page snapshot with substitute content corresponding to page resource(s), snapshot creation engine 202 is configured to prevent delayed loading for the affected page resources to enable the (original content of the) page resources to load/render properly prior to taking a page snapshot of the webpage, as will be described in further detail below.

In some embodiments, a web browser application is executing at snapshot creation engine 202 and is configured to load and/or render the webpage. The web browser application can be modifiable or configured to, at least in part, perform prevention of delayed loading. In some embodiments, a snapshot tool is executing at snapshot creation engine 202. The snapshot can be modifiable or configured to create a snapshot of a rendered webpage.

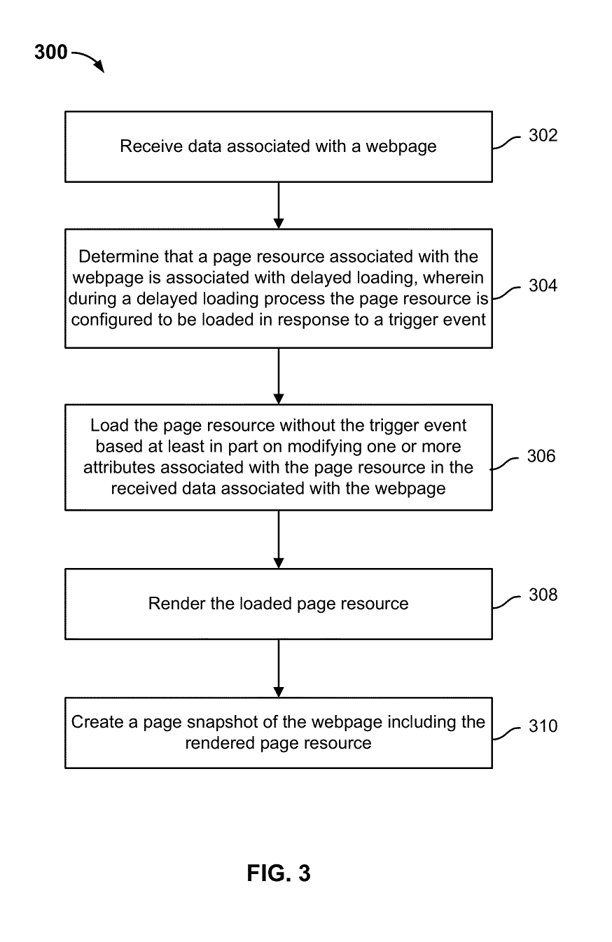

FIG. 3 is a flow diagram showing an embodiment of a process for creating a snapshot of a webpage. In some embodiments, process 300 is implemented at system 200 of FIG. 2.

At 302, data associated with a webpage is received.

For a webpage of which a page snapshot is desired, a request for a webpage file corresponding to the webpage is sent to an entity that stores such data. For example, the request may comprise a HyperText Transfer Protocol (HTTP) request message. The entity that stores the requested data may comprise a web server or a content cache server. The received data associated with the webpage may comprise a webpage file associated with the webpage. The webpage file can be a HyperText Markup Language (HTML) webpage file. The received data can be stored locally.

A page snapshot can be created for any type of webpage. As a first example, a page snapshot can be created for an existing webpage that has been updated. As a second example, a snapshot can be created for a new webpage.

At 304, a page resource associated with the webpage is determined to be associated with delayed loading, wherein during a delayed loading process the page resource associated with delayed loading is configured to be loaded in response to a trigger event.

In some embodiments, the received webpage file is parsed and the page resources included in the webpage are copied from the webpage file into a page resource list. Examples of a page resource include an image, an audio clip, and a video. However, for purposes of illustration, a page resource that is an image is discussed in various examples described herein.

As described above, delayed loading techniques delay the loading of certain page resources until trigger events associated with the page resources occur. For example, trigger events associated with a page resource include a user scrolling to a region of the webpage that is in the vicinity of the page resource, a user clicking or moving a cursor over a region of the webpage that is in the vicinity of the page resource, or a user moving the display area of the webpage within proximity to the page resource. For example, during loading of a page that includes a page resource associated with delayed loading, a substitute content is initially loaded in place of the original content of the page resource. The original content associated with the page resource is the content that is desired to be presented at the fully rendered webpage and the substitute content is loaded in place of the original content until the trigger event associated with the page resource occurs. Loading a substitute content or the original content of the page resource can including retrieving the content from a corresponding location/address/source. In some embodiments, the substitute content and/or original content is loaded by a web browser application.

For example, the substitute content comprises a blank image or other image of a relatively small size (and therefore has a short loading and/or rendering time). The substitute content of the page resource may comprise a predetermined image. The original content of the page resource may comprise an image that is of a larger size than the substitute content. This way, the blank image participates in page rendering and the original content of the page resource is only loaded in response to a configured trigger event. For example, the trigger event of the page scrollbar of a web browser approaching a blank image corresponding to a page resource may trigger the loading and rendering of the original image corresponding to that page resource. Delayed loading can result in the incomplete rendering of page resources contained in the page for which trigger events have not yet occurred.

In various embodiments, creating a page snapshot of a webpage does not cause trigger events associated with delayed loading to occur. As such, if there are page resources in the webpage that are associated with delayed loading, then such page resources will not load and/or will not be rendered properly in a conventional page snapshot creation process. As a result, a page snapshot created by a conventional page snapshot process may include blank or otherwise incomplete areas where page resources associated with delayed loading have not been triggered to be loaded and/or rendered.

To create a page snapshot that is not adversely affected by delayed loading, in various embodiments, the loading of page resources of the webpage that are associated with delayed loading is modified such that the original content of such a page resource can be loaded without the occurrence of a trigger event. In various embodiments, modifying the loading of a page resource associated with delayed loading such that the original content of the page resource can be loaded without the trigger event is called “preventing delayed loading.” In some embodiments, in performing the preventing of delayed loading, first, each page resource of the webpage that is configured to be associated with delayed loading is identified. For example, a page resource can be identified to be associated with delayed loading based on one or more attributes associated with the page resource in the webpage file.

At 306, the page resource is loaded without the trigger event based at least in part on modifying one or more attributes associated with the page resource in the received data associated with the webpage.

For each page resource that is identified to be associated with delayed loading, the attributes associated with the page resource in the webpage file are modified in the local copy of the webpage file such that the modified attributes cause the original content of the page resource to be loaded instead of the not yet loaded substitute content or to replace an already loaded substitute content of that page resource. In some embodiments, the modified attributes comprise a computer program that is configured to trigger the loading of the page resource. In some embodiments, a computer program (e.g., a JavaScript program) is configured to load a page resource whose attributes have been modified in the local copy of the webpage file.

By virtue of modifying the attributes of a page resource previously associated with delayed loading, the original content of a page resource can be loaded without the occurrence of the corresponding trigger event.

At 308, the loaded page resource is rendered. After a page resource has been loaded (e.g., retrieved from its location/address/source), the page resource can be rendered. In some embodiments, the page resource is rendered by a web browser application. In some embodiments, the page resource is rendered by a separate page snapshot creation application.

At 310, a snapshot of the webpage including the rendered page resource is created. In response to an indication that all the page resources, including those associated with and those not associated with delayed loading, have been successfully rendered (e.g., by the web browser), along with other content of the webpage, a page snapshot can be created based on the fully rendered webpage. In various embodiments, successful rendering refers to complete loading of all the page resources of the webpage. In some embodiments, in addition to complete loading of all the page resources of the webpage, successful rendering also refers to the complete displaying of all the page resources of the webpage either within a web browser application or in some other manner such that the page resources can be captured by a page snapshot creation application. For example, the page snapshot may be created by the web browser application or the page snapshot creation application that is separate from the web browser.

In some embodiments, the page snapshot can be automatically created by a computer program based on the detection of the completed rendering of all page resources of the webpage. In some other embodiments, the page snapshot can be automatically created using a user graphic interface associated with a screen capture tool to capture an image of the page.

In some embodiments, process 300 is implemented using a programmable web browser and a programmable screenshot tool.

Due to the prevention of delayed loading, the rendered webpage and corresponding page snapshot should have all the complete, rendered page resources. The page snapshot can be stored with other information associated with the webpage.

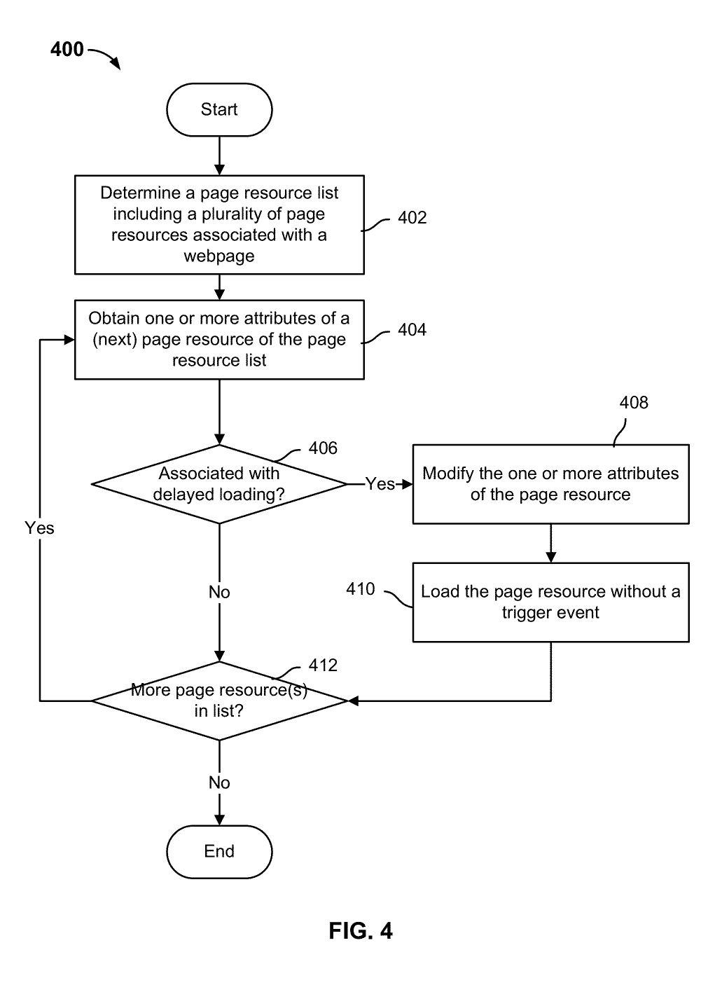

FIG. 4 is a flow diagram showing an embodiment of a process for preventing delayed loading. In some embodiments, process 400 is implemented at system 200 of FIG. 2. In some embodiments, 304, 306, and 308 of process 300 of FIG. 3 can be implemented using process 400.

Process 400 shows an example process of preventing delayed loading for page resources associated with a particular webpage. For example, process 400 can be performed before a page snapshot is created for the webpage. In some embodiments, process 400 is implemented using a JavaScript program. In some embodiments, process 400 is performed by a web browser application, by a separate computer (e.g., JavaScript) program that interacts with the web server.

At 402, a page resource list including a plurality of page resources associated with a webpage is determined. In some embodiments, the (e.g., HTML) file associated with the webpage is obtained. The file is traversed for page resources and a page resource list comprising each page resource is determined.

At 404, one or more attributes of a (next) page resource from the page resource list are obtained. Each page resource contained in the page resource list is sequentially retrieved and the attributes of that page resource are obtained from the file. For example, the attributes of the page resource may comprise a portion of the HTML file corresponding to the page resource. For example, a page resource may be associated with an HTML <img> tag of the HTML file.

At 406, is determined whether the page resource is associated with delayed loading based at least in part on the obtained one or more attributes. In the event it is determined that the page resource is associated with delayed loading, control is transferred to 408. Otherwise, in the event it is determined that the page resource is not associated with delayed loading, control is transferred to 412.

Based on the attributes associated with the page resource, it is determined whether the page resource is associated with delayed loading.

In some embodiments, the page resource is an image. If delayed loading technology is used to load a page, the original HTML file of the page is updated accordingly (prior to implementing process 400). For example, the src attributes of at least some statements of the HTML file that correspond to page resources (images) are updated. In the original HTML file, each page resource can be represented with the <img> tag and the location of the original image of the page resource can be indicated by its corresponding address (e.g., universal resource locator (URL)) in the value of the attribute src. For example, the tag information <img src=“./ture/path/of/image.jpg”> in the original HTML file represents that the original content (the original image) of page source A can be retrieved from the URL “./ture/path/of/image.jpg.” In updating the HTML file to enable delayed loading for page resource A, the original statement, <img src=“./ture/path/of/image.jpg”>, is updated to the following statement: <img src=“./empty.jpg” src2=“./ture/path/of/image.jpg”>. In the updated statement, the URL (“./empty.jpg”) of a substitute content (a substitute image) is substituted for the URL of the original image of page resource A as the value of the attribute src and the URL of the original image is saved under a new attribute, attribute src2. The substitute image can be a blank image of a predetermined size. If delayed loading were implemented for the webpage, then the substitute image would be loaded from src=“./empty.jpg” src2” first and then in response to a trigger event, the original image corresponding to page resource A would be loaded from src2=“./ture/path/of/image.jpg” to replace the substitute image.

In some embodiments, a page resource is determined to be associated with delayed loading if the page resource tag information (e.g., <img>) associated with the page resource includes another attribute in addition to the attribute src. For example, the additional attribute can be src2. Due to the presence of attribute src2 within the <img> tag information of the page resource, it is assumed that the URL of the original image of the page resource is the value of attribute src2 and the URL of the substitute image (e.g., a blank image) has been used as the value of attribute src.

Likewise, in some embodiments, a page resource is determined not to be associated with delayed loading if the <img> tag information associated with the page resource does not include an attribute in addition to the attribute src. In some embodiments, a page resource that is determined to not be associated with delayed loading may be automatically loaded and rendered without any modification to its attributes within the webpage file.

At 408, the one or more attributes of the page resource are modified.

In the event that the attributes of the page resource are associated with delayed loading, then the attributes can be modified within the local copy of the webpage file to cause the page resource to load without the occurrence of the trigger event that would have otherwise triggered delayed loading of the page resource. For example, the <img> tag information of the page resource in the local copy of the webpage file is <img src=”./empty.jpg” src2=”./ture/path/of/image.jpg”>. Because the <img> tag information of the page resource has another attribute other than attribute src, it is determined that the page resource is associated with delayed loading. In some embodiments, modifying the attributes of the page resource associated with delayed loading includes replacing the value of the address (e.g., URL) of the substitute image of the attribute src with the address (e.g., URL) of the original image that was stored as the value of the additional attribute (e.g., attribute src2). By modifying the attributes of the page resource as such, the value of the attribute src of the page resource is restored from the address of the substitute image to the address of the original image corresponding to the page resource. For the example where the <img> statement of the page resource in the local copy of the webpage file is <img src=”./empty.jpg” src2=”./ture/path/of/image.jpg”>, the modified version comprises the following statement <img src=“./ture/path/of/image.jpg”>. In this example, not only is the address of the original image corresponding to the page resource substituted back as the value of attribute src, the additional attribute, attribute src2 is removed/deleted.

At 410, the page source is loaded without a trigger event. The page resource whose attributes have been modified within the local copy of the webpage file is loaded. Due to the modification of the attributes of the page resource, delayed loading will no longer apply to the page resource and the page resource can be loaded based on the modified attributes without requiring the occurrence of a trigger event. For example, a computer program associated with performing delayed loading of a page resource based on the attributes of the page resource will no longer recognize the page resource as being associated with delayed loading. Thus, a page resource with attributes modified as described herein will be loaded and rendered via a normal loading/rendering procedure that does not occur based on a trigger event. For example, assume that the modified tag information for a page resource is <img src=“./ture/path/of/image.jpg”>. Therefore, the page resource will be retrieved from URL “./ture/path/of/image.jpg” and rendered.

In some embodiments, if the substitute image (e.g., a blank image) corresponding to the page resource had already been loaded and/or rendered, then the modification of the attributes of the page resource and/or loading of the page resource based on the modified attributes would replace the rendered image of the substitute image with the rendered original image corresponding to the page resource.

At 412, it is determined whether there is at least one more page resource in the page resource list. In the event it is determined that there is at least one more page resource in the page resource list, control is returned to 404. Otherwise, in the event it is determined that there are no more page resources in the page resource list, process 400 ends. Each page resource of the page resource list is examined for associations with delayed loading until the entire list has been traversed.

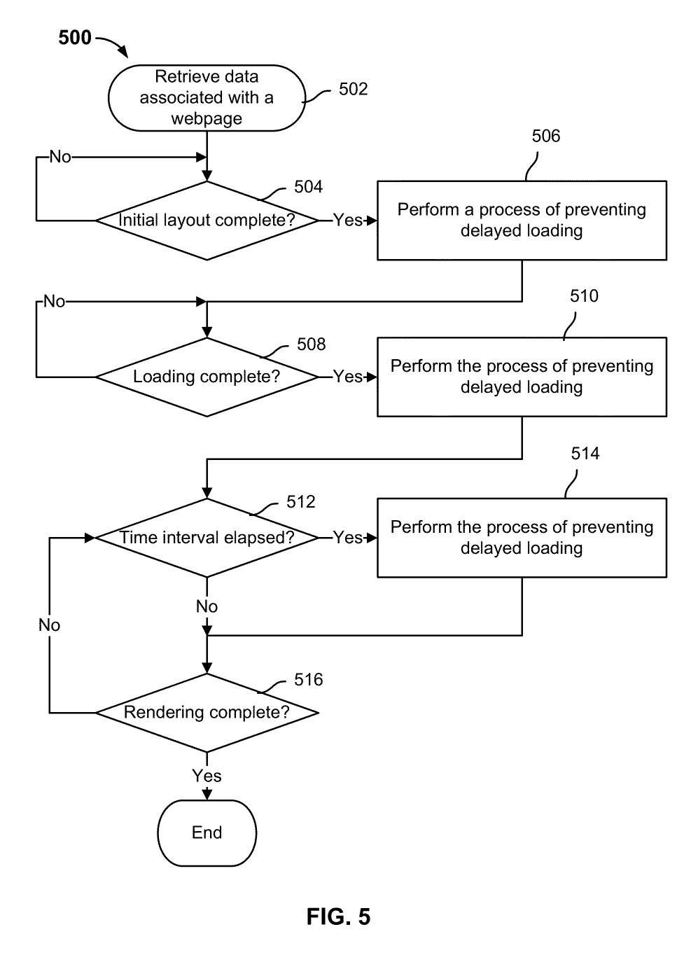

FIG. 5 is a flow diagram showing an embodiment of a process for triggering a process of preventing delayed loading. In some embodiments, process 500 is implemented at system 200 of FIG. 2.

In some embodiments, during the course of rendering page resources for a webpage prior to creating a page snapshot of the webpage, a process of preventing delayed loading, such as process 400 of FIG. 4, is initiated one or more times. Process 500 describes an example process of determining when to cause a process of preventing delayed loading to be performed prior to creating a page snapshot of the webpage.

In some embodiments, prior to creating a page snapshot of a webpage, a process of preventing delayed loading, such as a process 400 of FIG. 4, can be configured to be performed in response to one or more trigger signals. For example, the process of preventing delayed loading can be described to be bound to one or more trigger signals. Each trigger signal is generated based on the occurrence of a specified event associated with the process of a webpage being loaded and/or rendered (e.g., in a web browser application). As such, the configuration of binding one or more trigger signals to cause the performance of a process of preventing delayed loading can be pre-stored. Then, during the loading and/or rendering of a webpage (e.g., by the web browser), when a specified event occurs, a trigger signal corresponding to the event is generated and the process of preventing delayed loading can be triggered in response to the detected trigger signal. During the process of loading and/or rendering the webpage, a process of preventing delayed loading can be caused to be performed one or more times, corresponding to the number of trigger signals corresponding to specific events that occur.

It may be desirable to cause the process of preventing delayed loading to be triggered more than one time during the loading and/or rendering of the webpage because it is possible for a process of preventing delayed loading to be interrupted (e.g., due to poor network connection and/or other reasons) before the process can prevent delayed loading for each page resource associated with delayed loading in the webpage. For example, the process of preventing delayed loading described by process 400 of FIG. 4 can be interrupted prior to the entire page resource list being traversed. As such, by configuring multiple trigger signals (each corresponding to a potentially different specified event) to cause the process of preventing delayed loading to be performed, it is more likely for preventing delayed loading to be applied to all the page resources that are associated with delayed loading in the webpage. In each subsequent trigger of the process of preventing delayed loading, page resources that have already been processed by preventing delayed loading in a previous iteration of preventing delayed loading can be skipped.

A first example of a specified event that is configured to cause the generation of a trigger signal that is configured to cause the process of preventing delayed loading to be performed is an initial layout completion event (e.g., the QWebFrame intialLayoutCompleted signal as specified by Qt cross-platform application framework). For example, the layout completion event of the webpage can refer to when the frame is laid for the first time and/or the HTML structure of the webpage file that has already been rendered into the web browser.

A second example of a specified event that is configured to cause the generation of a trigger signal that is configured to cause the process of preventing delayed loading to be performed is a load completion event (e.g., the QWebFrame loadFinished signal as specified by Qt cross-platform application framework). For example, the load completion event of the webpage can refer to the completion of loading of the frame and/or contents (e.g., page resources) included in the frame. For example, if a page resource that is associated with delayed attributes has not yet been subjected to the process of preventing delayed loading, the substitute image (e.g., a blank image) corresponding to the page resource can be loaded.

At 502, data associated with a webpage is retrieved. The (e.g., HTML) webpage file of a webpage, for example, for which a page snapshot is to be created is retrieved.

At 504, it is determined whether an initial layout completion event has occurred. In the event that the trigger signal (e.g., QWebFrame intialLayoutCompleted signal as specified by Qt cross-platform application framework) corresponding to the initial layout completion event has been detected, control is transferred to 506. Otherwise, in the event that the trigger signal corresponding to the initial layout completion event has not been received, the signal is waited for. At 506, a process of preventing delayed loading is performed. In some embodiments, the preventing delayed loading of process 400 of FIG. 4 is performed at 506. In some embodiments, the preventing delayed loading process is implemented as an injected JavaScript program.

In some embodiments, before the trigger signal associated with the initial layout completion event is detected, loading has not yet begun. But after the trigger signal associated with the initial layout completion event is detected, loading begins.

At 508, it is determined whether a loading completion event has occurred. In the event that the trigger signal (e.g., QWebFrame loadFinished signal as specified by Qt cross-platform application framework) corresponding to load completion event has been detected, control is transferred to 510. Otherwise, in the event that the trigger signal corresponding to initial layout completion event has not been received, the signal is waited for. At 510, the process of preventing delayed loading is performed.

As loaded page resources are being rendered for the webpage, it is possible for rendering of certain loaded page resources to fail. For example, while a loaded page resource is being loaded, a slow network connection may cause the rendering of the page resource to fail. In some embodiments, after the loading completion event has been detected, some time may pass before the loaded page resources are completely rendered. Therefore, during the time after the loading completion event and the rendering completion event, the process of preventing delayed loading (e.g., process 400 of FIG. 4) may be periodically performed every preset time interval to make sure that the page resources that were previously affected by delayed loading can be successfully loaded by preventing delayed loading and then successfully rendered.

At 512, it is determined whether a preset time interval has elapsed. In the event that it has been determined that the preset time interval has passed, control is transferred to 514, where the process of delayed loading is performed. Otherwise, in the event that it has been determined that the preset time interval has not yet passed, control is transferred to 516.

At 516, it is determined whether rendering of the webpage has completed. In the event that it has been determined that the rendering of the webpage has completed, process 500 ends. Otherwise, in the event that it has been determined that the rendering of the webpage has not yet completed, control is returned to 512. When the webpage has been completely rendered, then a snapshot can be created from the webpage, in some embodiments.

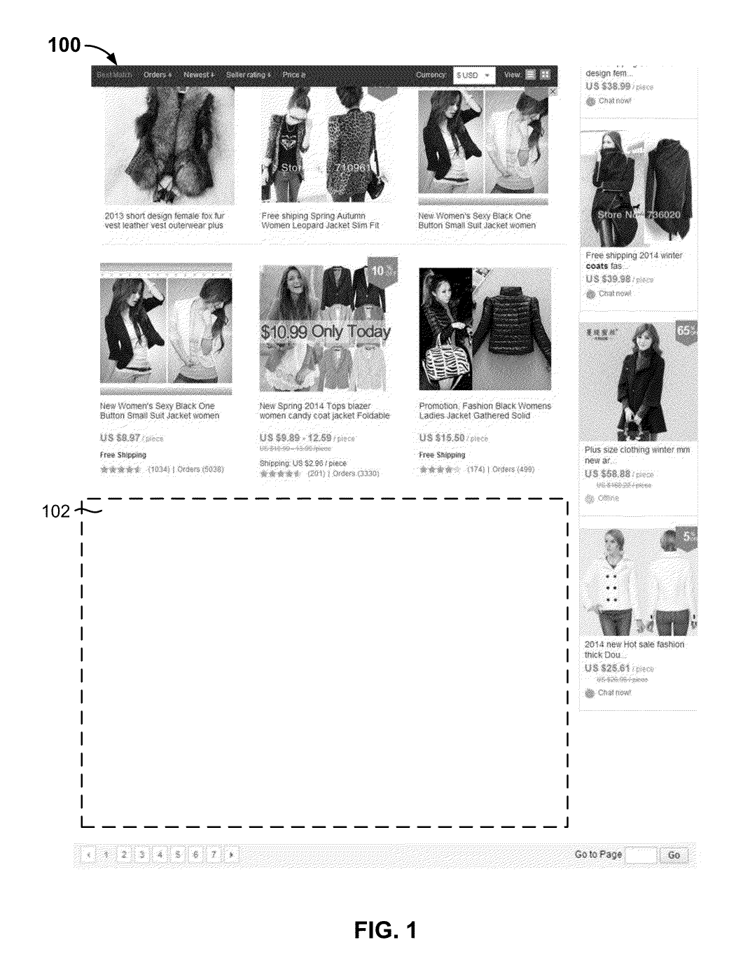

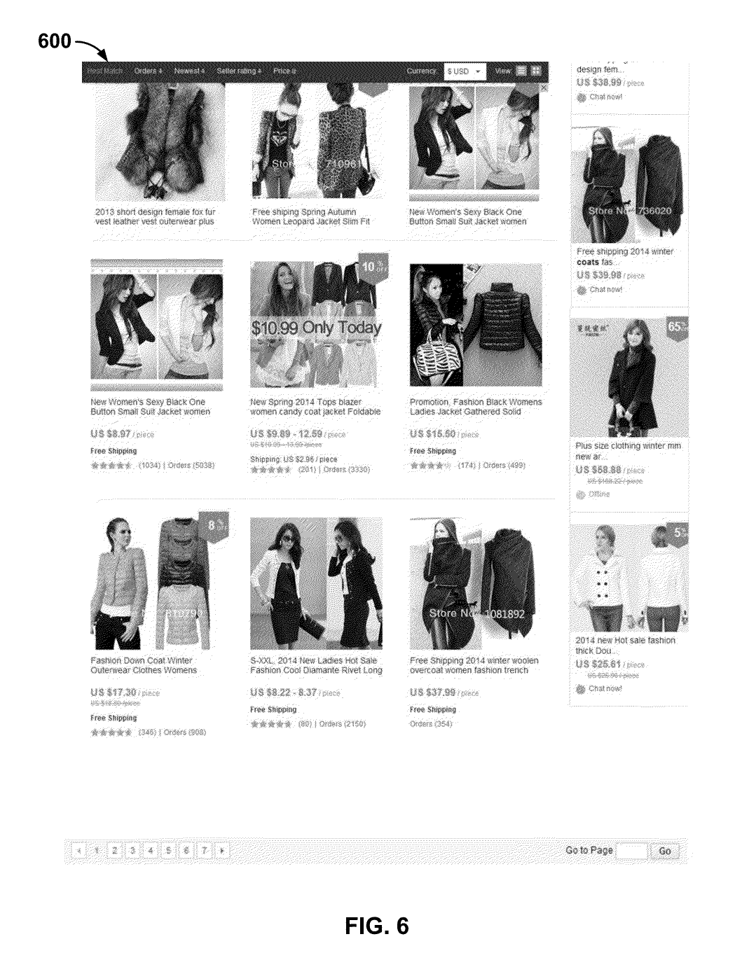

FIG. 6 is a diagram showing an example of a page snapshot of a webpage for which preventing delayed loading was applied. In the example of FIG. 6, page snapshot 600 was created using a process such as process 300 of FIG. 3. Because preventing delayed loading was applied to the webpage such that all the page resources of the webpage could be properly loaded and rendered prior to creating page snapshot 600, page snapshot 600 includes complete renderings of all page resources. Unlike page snapshot 100 of FIG. 1, for which certain page resources were still associated with delayed loading, page snapshot 600 does not include incomplete and/or blank areas, such as blank region 102 of page snapshot 100 of FIG. 1. For example, page snapshot 600 can be stored by a search engine, such that when the webpage is included among search results presented by the search engine, a link to page snapshot 600 can be displayed with the search result for the user to access to view page snapshot 600.

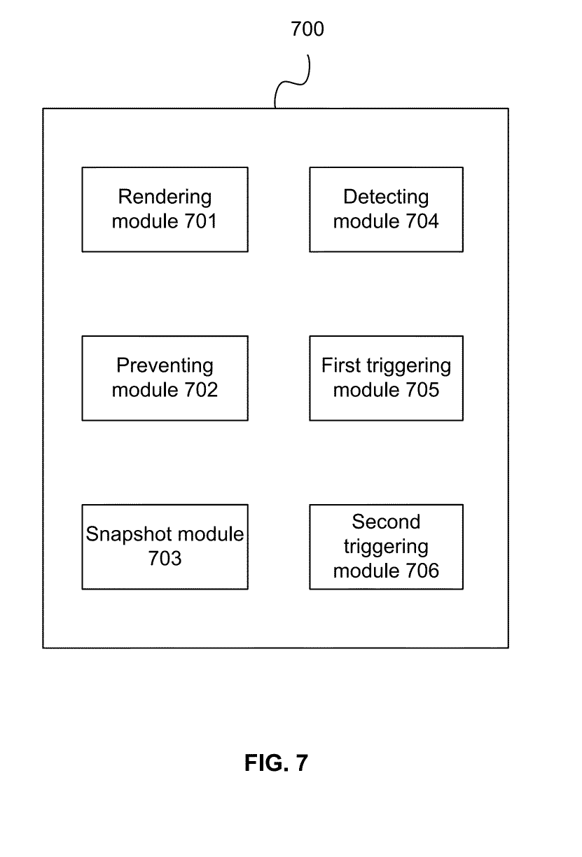

FIG. 7 is a diagram showing an embodiment of a system for preventing delayed loading. In the example, system 700 includes rendering module 701, preventing module 702, snapshot module 703, detecting module 704, first triggering module 705, and second triggering module 706.

The modules and sub-modules can be implemented as software components executing on one or more processors, as hardware such as programmable logic devices and/or Application Specific Integrated Circuits designed to elements that can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules and sub-modules may be implemented on a single device or distributed across multiple devices.

Rendering module 701 is configured to receive data associated with a webpage. Rendering module 701 is also configured to render each loaded page resource of the webpage.

Preventing module 702 is configured to perform preventing delayed loading. Preventing delayed loading includes determining that a page resource associated with the webpage is associated with delayed loading, wherein the page resource is configured to be loaded in response to a trigger event. Preventing delayed loading further includes loading the page resource without the trigger event based at least in part on modifying one or more attributes associated with the page resource in the received data associated with the webpage.

Detection module 704 is configured to detect one or more trigger signals associated with corresponding specified events of the page rendering process. A first example of a specified event is the initial layout completion and a second example of a specified event is the loading completion event. In response to a detection of a trigger signal corresponding to a specified event, detection module 704 is configured to send a message to first triggering module 705. In response to receiving such a message, first triggering module 705 is configured to trigger preventing module 702 to perform preventing delayed loading.

After detection by detecting module 704 of the last specified event in the page rendering process, second triggering module 706 is configured to trigger preventing module 702 to perform preventing delayed loading every preset time interval until page rendering is complete.

Snapshot module 703 is configured to create a snapshot of the webpage after the page resources have been completely rendered.

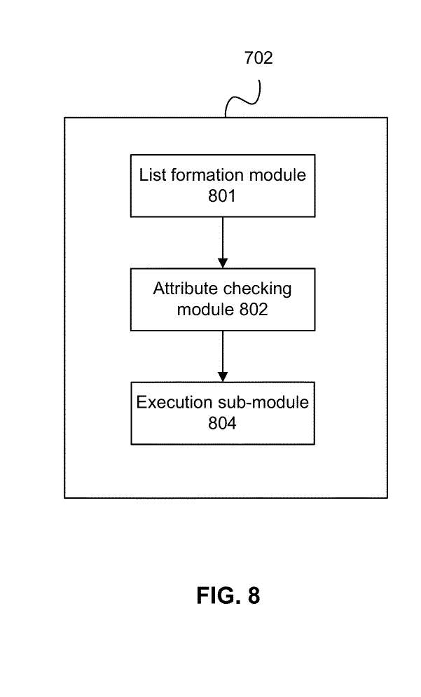

FIG. 8 is a diagram showing an example of a preventing module. In some embodiments, preventing module 702 of system 700 of FIG. 7 can be implemented with the example of FIG. 8. In the example, the preventing module includes: list formation module 801, attribute checking module 802, and execution sub-module 804. List formation module 801 is configured to determine a page resource list including a plurality of page resources associated with a webpage. Attribute checking module 802 is configured to obtain the attributes of each page resource contained in the page resource list and check whether the attributes of the page resource are associated with delayed loading. Execution sub-module 804 is configured to modify the one or more attributes of a page resource associated with delayed loading such that the original image corresponding to the page resource will be loaded instead of the substitute image and without a trigger event.

The various embodiments in this description are generally described in a progressive manner. The explanation of each embodiment focuses on areas of difference from the other embodiments, and the descriptions thereof may be mutually referenced for portions of the embodiments that are identical or similar.

The present application can be described in the general context of computer executable commands executed by a computer, such as a program module or unit. Generally, program modules or units can include routines, programs, objects, components, data structures, etc. to execute specific tasks or achieve specific abstract data types. Typically, the program module or unit can be realized by software, hardware, or a combination of the two. The present application can also be carried out in distributed computing environments. In such distributed computing environments, tasks are executed by remote processing equipment connected via communication networks. In distributed computing environments, program modules or units can be located on storage media at local or remote computers that include storage equipment.

A person skilled in the art should understand that the embodiments of the present application can be provided as methods, systems, or computer program products. Therefore, the present application may take the form of complete hardware embodiments, complete software embodiments, or embodiments that combine software and hardware. In addition, the present application can take the form of computer program products implemented on one or more computer-operable storage media (including but not limited to magnetic disk storage devices, CD-ROMs, and optical storage devices) containing computer operable program codes.

This document has employed specific embodiments to expound the principles and forms of implementation of the present application. The above embodiment explanations are only meant to aid in comprehension of the methods of the present application and of its main concepts. Moreover, a person with general skill in the art would, on the basis of the concepts of the present application, be able to make modifications to specific forms of implementation and to the scope of applications. To summarize the above, the contents of this description should not be understood as limiting the present application.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
receive data associated with a webpage;
determine that a page resource associated with the webpage is associated with delayed loading, wherein during a delayed loading process the page resource is configured to be loaded in response to a trigger event;
load the page resource without the trigger event based at least in part on modifying one or more attributes associated with the page resource in the received data associated with the webpage;
render the loaded page resource; and
create a page snapshot of the webpage including the rendered page resource; and
one or more memories coupled to the one or more processors and configured to provide the one or more processors with instructions.

2. The system of claim 1, wherein the data associated with the webpage comprises a Hypertext Markup Language (HTML) file.

3. The system of claim 1, wherein the trigger event is associated with a user selection with respect to the webpage.

4. The system of claim 1, wherein the page resource is associated with a substitute content and an original content, wherein without the modifying of the one or more attributes associated with the page resource, the substitute content is configured to be loaded first and in response to the trigger event, the original content is configured to be loaded.

5. The system of claim 4, wherein loading the page resource without the trigger event based at least in part on the modifying of the one or more attributes includes loading the original content.

6. The system of claim 1, wherein the one or more processors are further configured to determine a page resource list including a plurality of page resources associated with the webpage.

7. The system of claim 1, wherein modifying the one or more attributes associated with the page resource in the received data associated with the webpage includes modifying a page resource tag information associated with the page resource.

8. The system of claim 7, wherein the page resource tag information comprises <img> tag information.

9. The system of claim 7, wherein modifying the page resource tag information associated with the page resource includes substituting a value of an attribute src of the page resource tag information with a value of an additional attribute of the page resource tag information.

10. The system of claim 1, wherein the determination that the page resource associated with the webpage is associated with delayed loading is performed in response to detecting a trigger signal.

11. The system of claim 10 wherein the trigger signal is associated with an initial layout completion event.

12. The system of claim 10, wherein the trigger signal is associated with a load completion event.

13. The system of claim 10, wherein the trigger signal is associated with an elapse of a preset time interval subsequent to a load completion event.

14. A method, comprising:
receiving data associated with a webpage;
determining, by one or more processors, that a page resource associated with the webpage is associated with delayed loading, wherein during a delayed loading process the page resource is configured to be loaded in response to a trigger event;
loading the page resource without the trigger event based at least in part on modifying one or more attributes associated with the page resource in the received data associated with the webpage;
rendering the loaded page resource; and
creating a page snapshot of the webpage including the rendered page resource.

15. The method of claim 14, wherein the trigger event is associated with a user selection with respect to the webpage.

16. The method of claim 14, wherein the page resource is associated with a substitute content and an original content, wherein without the modifying of the one or more attributes associated with the page resource, the substitute content is configured to be loaded first and in response to the trigger event, the original content is configured to be loaded.

17. The method of claim 16, wherein loading the page resource without the trigger event based at least in part on the modifying of the one or more attributes includes loading the original content.

18. The method of claim 14, further comprising determining a page resource list including a plurality of page resources associated with the webpage.

19. The method of claim 14, wherein modifying the one or more attributes associated with the page resource in the received data associated with the webpage includes modifying a page resource tag information associated with the page resource.

20. The method of claim 19, wherein modifying the page resource tag information associated with the page resource includes substituting a value of an attribute src of the page resource tag information with a value of an additional attribute of the page resource tag information.

21. A computer program product, the computer program product being embodied in a non-transitory computer readable storage medium and comprising instructions for:
receiving data associated with a webpage;
determining that a page resource associated with the webpage is associated with delayed loading, wherein during a delayed loading process the page resource is configured to be loaded in response to a trigger event;
loading the page resource without the trigger event based at least in part on modifying one or more attributes associated with the page resource in the received data associated with the webpage;
rendering the loaded page resource; and
creating a page snapshot of the webpage including the rendered page resource.
